(19) United States
(12) Patent Application Publication
(10) Pub. No.: US 2014/0362575 A1
(43) Pub. Date: Dec. 11, 2014

(54) FLEXIBLE LIGHT PANEL

(71) Applicant: John E. Shirilla, Davidson, NC (US)

(72) Inventor: John E. Shirilla, Davidson, NC (US)

(21) Appl. No.: 13/912,751

(22) Filed: Jun. 7, 2013

(51) Int. Cl. F21V 21/14; F21V 21/005

(52) U.S. Cl. CPC F21V 21/145; F21V 21/005
USPC 362/249.08

(57) ABSTRACT

One or more techniques and/or systems are disclosed for a lighting apparatus. A base panel can comprise a flexible material that is configured to be manipulated into a first configuration, comprising a compact arrangement, and a second configuration, comprising a use arrangement. A lighting element holding panel, operably engaged with the base panel, can comprise a plurality of pockets, each configured to receive at least one lighting element; and can be comprised of a flexible transparent and/or translucent material. At least one of a plurality of lighting elements can be disposed in each pocket of the lighting element holding panel; where each of the lighting elements may comprise one or more light emitting semiconductors that are configured to produce white light. The flexible base panel and holding panel may allow the lighting apparatus to be compacted for storage and/or transport, and opened up for use.

### BACKGROUND

Lighting is often an important element of image capture, such as using traditional photography, filming and videography techniques, whether capturing scenery, live action, portraits, nature, etc., both indoors or outdoors. Further, various types of illumination effects may be desired used for live performances, such as on a stage. Lighting systems are typically used to illuminate a subject to provide a desired effect during image capture. Lighting can also be used to obtain a desired illumination effect, for example, by using lighting having a particular tone, warmth, or intensity. Further, certain lights may be used for particular purpose, for example, where the type of light emitted may be used for the specific purpose, such as anti-microbial treatment using ultra-violet lights, and/or general lighting of an area.

Current and prior lighting systems include incandescent or fluorescent lighting elements. However, these systems have limitations limiting their flexibility or effectiveness. As an example, mounting frames used these types of lighting systems are typically large and onerous, making them difficult to move, store and use. Incandescent lighting can generate large amounts of heat, which can causing discomfort to, or alter the properties of, the subject of the image; and/or may alter the image due to heat waves appearing in the image. Additionally, incandescent systems tend to draw a lot of electrical power, thereby resulting in larger generation or supply needs. Further, specific purpose lights are typically limited by a frame or mounting system used to hold and/or aim the lighting emitting devices.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

As provided herein, a light-providing system configured to be easily portable, configurable, modular, and efficient, and which provides the desired type of illumination, for example, during image capture and/or other purpose specific light-provision. A plurality of lamp elements may be arranged on a flexible panel. The lamp elements can be electrically coupled to a power supply line, which may be connected to an electrical supply (e.g., outlet). The flexible nature of the exemplary lighting system may allow it to be easily stowed, for example, by rolling the panel in a roll and selectively securing the roll configuration, such as using a fastener. Further, the exemplary lighting system may comprise attachment means for selectively attaching the flexible panel to a light holder system, such as for use during lighting use for image capture.

In one implementation, an exemplary lighting apparatus can comprise a base panel comprising a flexible material. The flexible material may be configured to be manipulated into a first configuration comprising a compact arrangement, and a second configuration comprising a use arrangement. Further, the exemplary lighting apparatus can comprise a lighting element holding panel that is operably engaged with the base panel. The lighting element holding panel can be configured to receive at least one lighting element. Additionally, the exemplary lighting apparatus can comprise a plurality of lighting elements, each disposed on the lighting element holding panel. Each of the lighting elements may comprise one or more light emitting semiconductors that are configured to produce light.

To the accomplishment of the foregoing and related ends, the following description and annexed drawings set forth certain illustrative aspects and implementations. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

What is disclosed herein may take physical form in certain parts and arrangement of parts, and will be described in detail in this specification and illustrated in the accompanying drawings which form a part hereof and wherein:

FIGS. 1A and 1B are component diagrams illustrating an exemplary lighting panel.

FIG. 2 is a component diagram illustrating a rear view of an example implementation of one or more portions of an exemplary lighting panel.

FIG. 3 is a component diagram illustrating example implementations of one or more portions of an exemplary lighting panel.

FIG. 4 is a component diagram illustrating an example implementation of one or more portions of an exemplary lighting panel.

FIGS. 5A, 5B and 5C are component diagrams illustrating example implementations of one or more portions of an exemplary lighting panel.

FIG. 6 is a component diagram illustrating an example implementation of one or more portions of an exemplary lighting panel.

FIGS. 7A and 7B are component diagrams illustrating an example implementation of one or more portions of an exemplary lighting panel.

FIGS. 8A and 8B are component diagrams illustrating an example implementation of one or more portions of an exemplary lighting panel.

FIG. 9 is a component diagram illustrating an example implementation of one or more portions of an exemplary lighting panel.

FIG. 10 is a component diagram illustrating an example implementation of one or more portions of an exemplary lighting panel.

FIG. 11 is a component diagram illustrating a rear view of an example implementation of one or more portions of an exemplary lighting panel.

FIGS. 12A and 12B are component diagrams illustrating an example implementation of one or more portions of an exemplary lighting panel.

FIGS. 13A and 13B are component diagrams illustrating example implementations of one or more portions of an exemplary lighting panel.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

An lighting system may be devised that may be relatively light-weight, readily portable, easy to work with, modular, and efficient, and, for example, may provide appropriate illumination during image capture, such as photography, videography, and/or stage lighting. A flexible panel may comprise plurality of lamp elements, which can respectively comprise light emitting semiconductors, such as light-emitting diodes (LEDs). The lamp elements may be arranged on the flexible panel in a manner that allows the lighting system to be easily compacted, and secured in the compact configuration for stowing and/or transportation. Further, the lighting system may be expanded for use, and may also comprise attachment means for selectively attaching the flexible panel to a light holding device. Further, the lighting panel may comprise any suitable configuration, shape and/or size, suited for a particular purpose, set-up, and/or location. As one example, the panel may comprise a size and/or shape that allows it to be wrapped around a subject (e.g., a portion of a person) for applying light therapy to the subject.

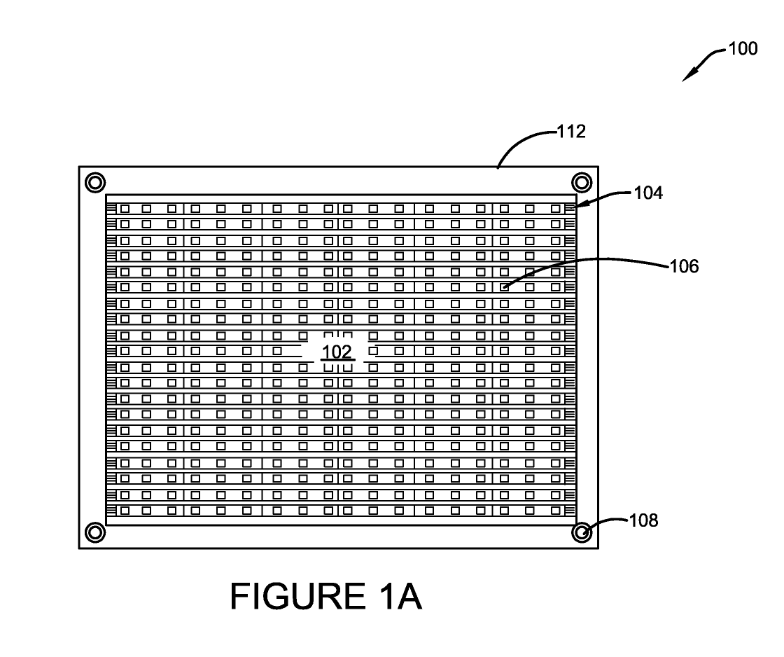

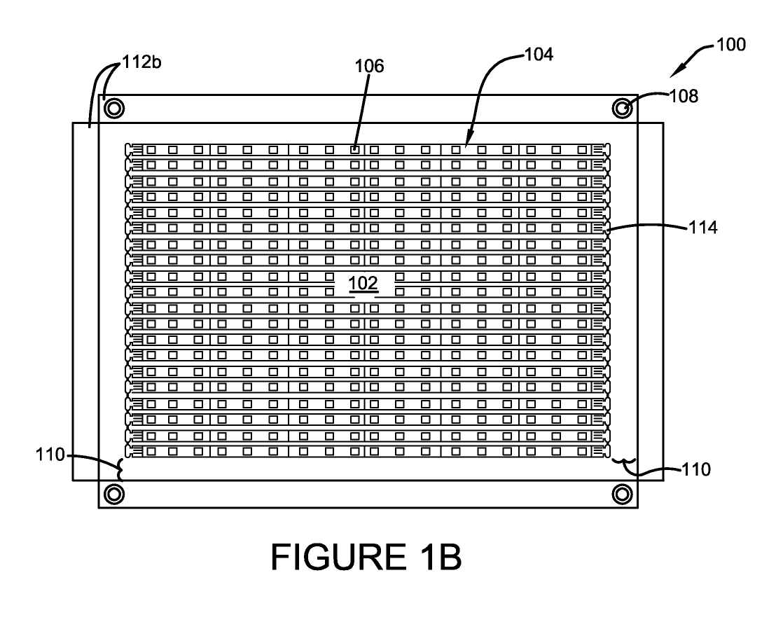

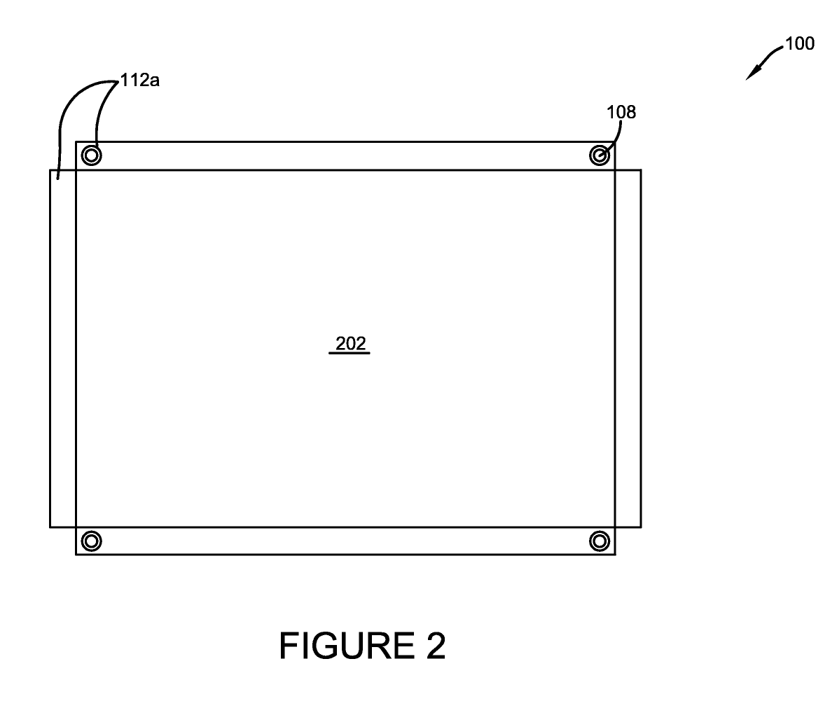

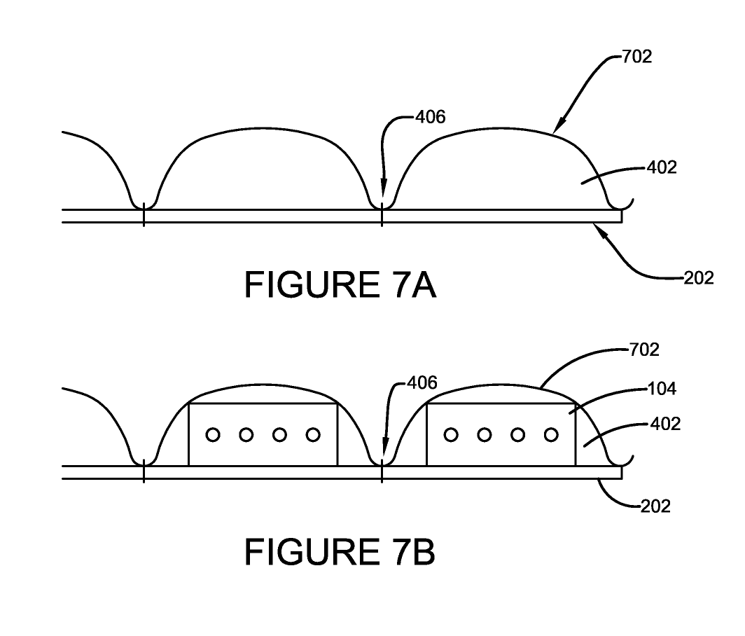

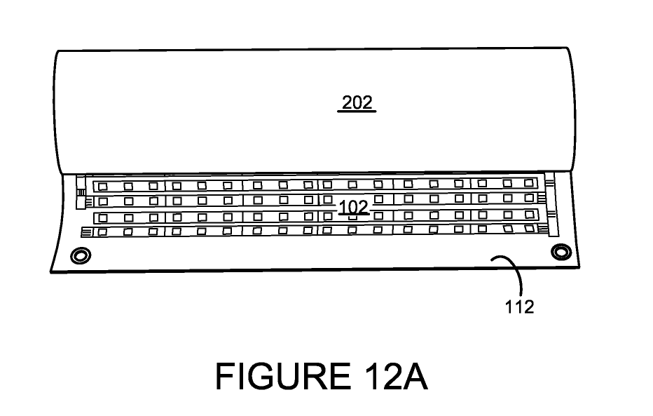

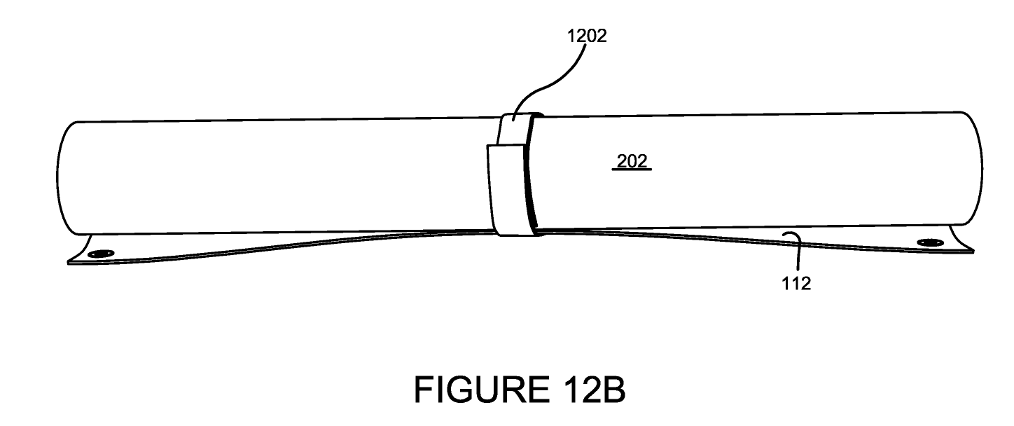

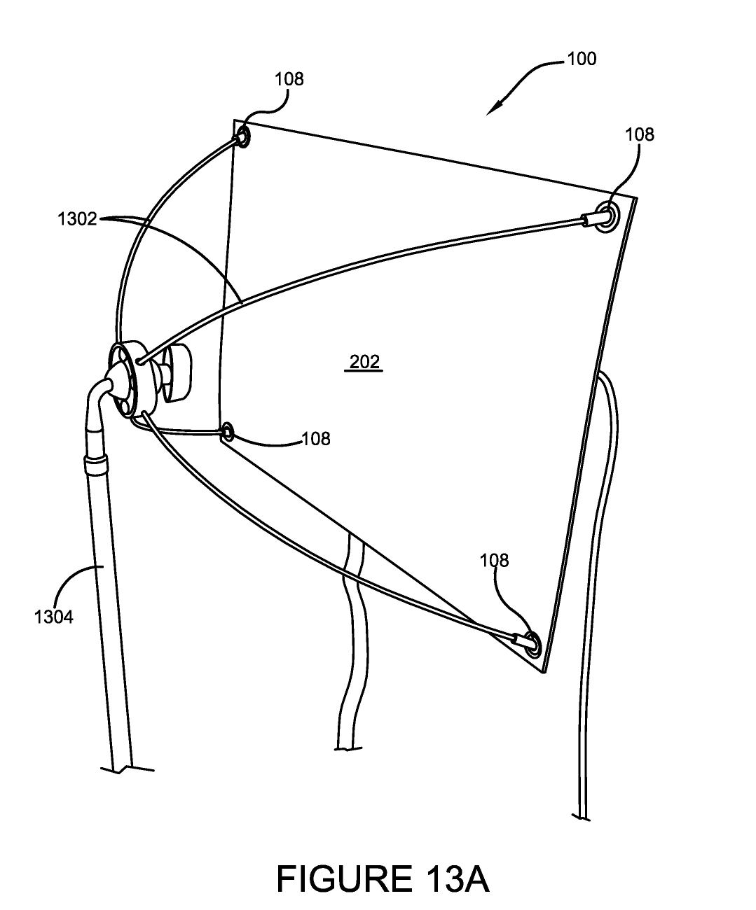

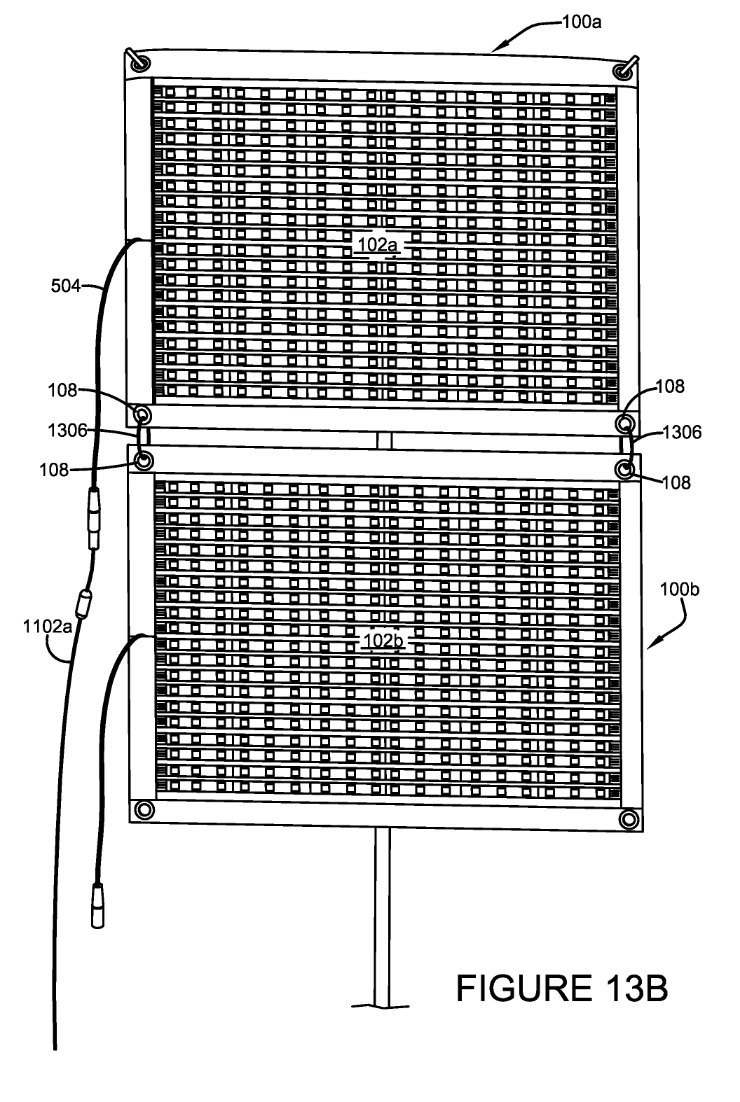

Now with reference to FIGS. 1A, 1B, 2-4 and 7, which illustrate one or more portions of an exemplary lighting system 100, as described herein. The exemplary lighting system 100 comprises a base panel 202 that comprises a flexible material. The base panel 202 may be manipulated into a first configuration, comprising a compact arrangement, and a second configuration, comprising a use arrangement. As an illustrative example, as illustrated in FIGS. 12A, 12B and 13A, in one implementation, the first configuration may comprise rolling the base panel 202 into a roll shape (e.g., or folding into a folded shape), as in FIGS. 12A and 12B. Further, in this implementation, the second configuration may comprise spreading the base panel 202 out to a flat-configuration so that it may be used, such as for providing lighting for an image capture event.

In one implementation, as illustrated in FIGS. 1A, 1B, 3, and 12A, the respective pockets 402 can be disposed in a same orientation, such that corresponding lighting elements 104 may also be disposed in a same direction. In this way, for example, the orientation may facilitate arranging the exemplary panel in a compact arrangement (e.g., rolled up). In one implementation, the respective pockets 402 can be arranged in a manner that facilitates folding the exemplary panel 100 in a desired compact arrangement (e.g., folding), such that the lighting elements 104 disposed in the pockets 402 are likewise arranged in a manner that facilitates folding the exemplary panel 100 in a desired compact arrangement.

As illustrated in FIGS. 1A, 1B, 2-4, 7A and 7B, the exemplary lighting system 100 comprises a lighting element holding panel 102 that is operably engaged with the base panel 202. The light element holding panel 102 can comprise a plurality of pockets 402, where the respective pockets may be configured to receive at least one lighting element 104. The light element holding panel 102 can comprise a flexible transparent material, and/or a flexible translucent material.

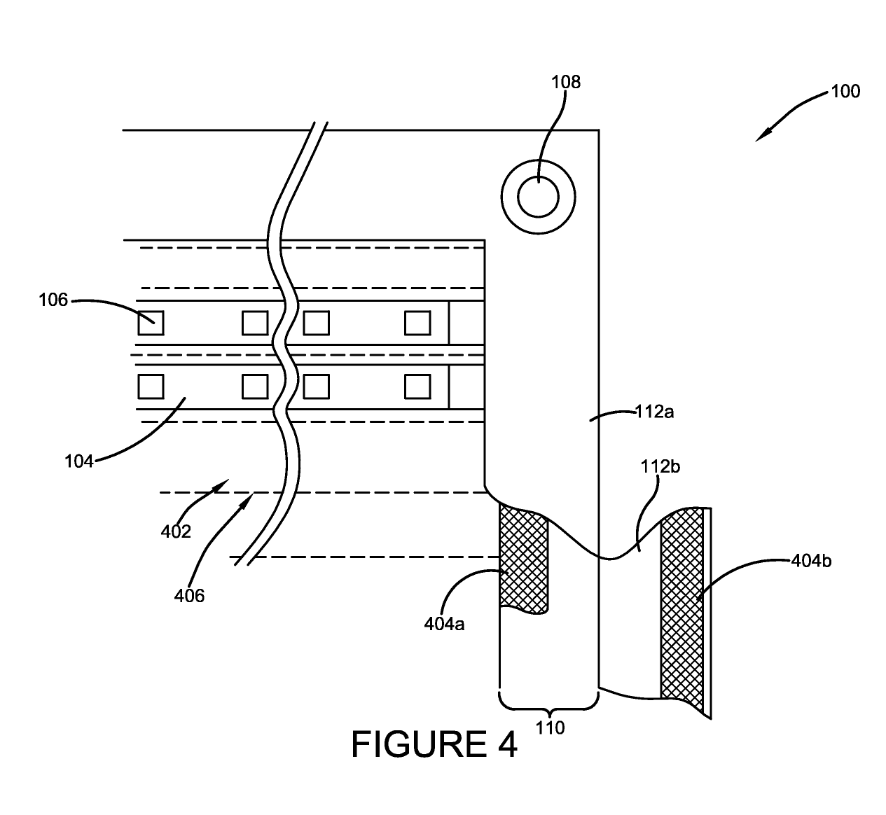

In one implementation, the lighting element holding panel 102 may be operably engaged with the base panel 202 using a fastening means. As one example, the lighting element holding panel 102 may be sewn (e.g., or glued, fastened, integrally formed with, etc.) onto the base panel 202. As an illustrative example, as illustrated in FIG. 4, 7A and 7B, with reference to FIGS. 1-3, the pockets 402 may be formed in the lighting element holding panel 102 by fastening the flexible material 702 of the lighting element holding panel 102 to the base panel 202 at one or more desired locations 406. For example, the flexible material 702 of the lighting element holding panel 102 can be sewn (e.g., or fastened) to the base panel 202 at the one or more desired locations 406, thereby forming the respective pockets in the portions of the flexible material 702 not sewn to the base panel 202.

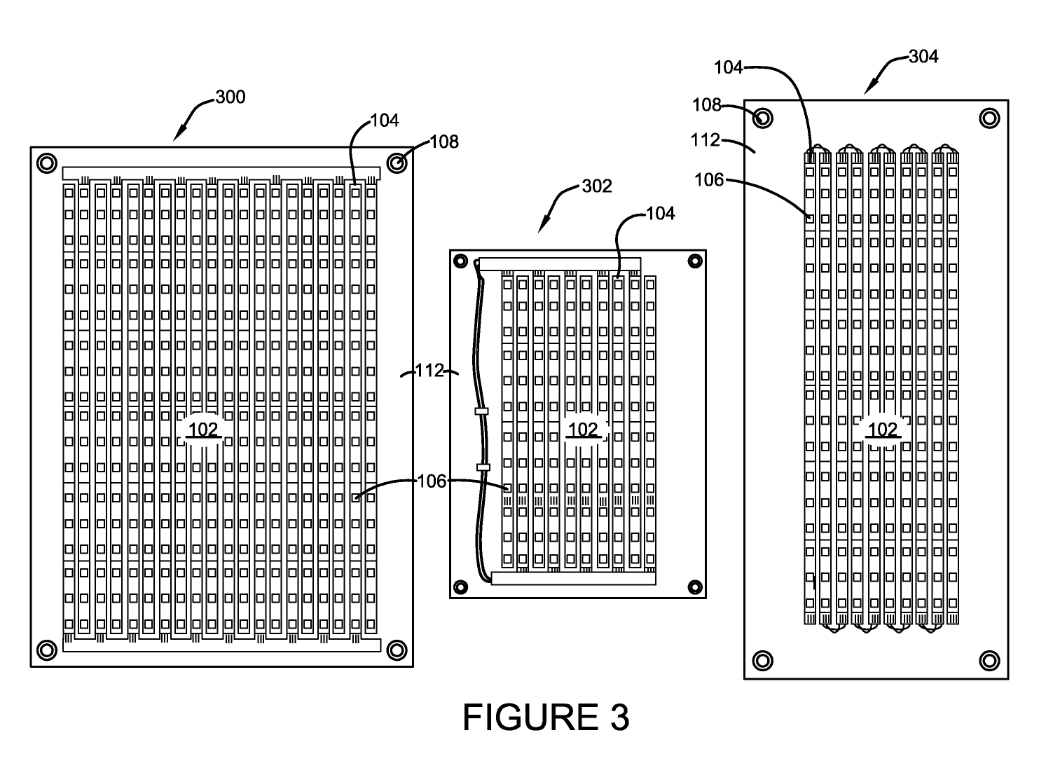

As illustrated in FIG. 3, the exemplary lighting apparatus 100 may be configured in various shapes and sizes 300, 302, 304. As an example, a size and/or shape of the exemplary lighting panel can be determined by an intended use, such as determined by the target lighting subject, lighting area, and/or available area for an imaging project. For example, the lighting panel 304 comprises a larger area that may provide more lighting than example panel 302 or 304. As another example, the configurations of panels 302 and 304 may be utilized in areas having specialized arrangements and/or smaller subjects.

The exemplary lighting panel 100 can comprise a plurality of lighting elements 104. Respective lighting elements 104 can be disposed in a pocket 402 of the lighting element holding panel 102. Further, respective lighting elements 104 can comprise one or more light emitting semiconductors 106 that are configured to produce white light. As an example, a light emitting semiconductor can comprise electrical circuitry that emits light when an electrical current is passed across a semi-conductor portion of the circuitry as electrons in the semi-conductor material recombine with electron holes to release photons.

In one implementation, the light emitting semiconductor may comprise a light emitting diode (LED). In one implementation, the light emitting semiconductor may comprise an organic light-emitting diode (OLED). In another implementation, the light emitting semiconductor may comprise a polymer light-emitting diode (PLED), or a light-emitting polymer (LEP), which can utilize an electroluminescent conductive polymer that emits photons when subjected to an electrical current. In another implementation, the light emitting semiconductor may comprise a light-emitting electrochemical cell (LEC), which can generate light using electroluminescence.

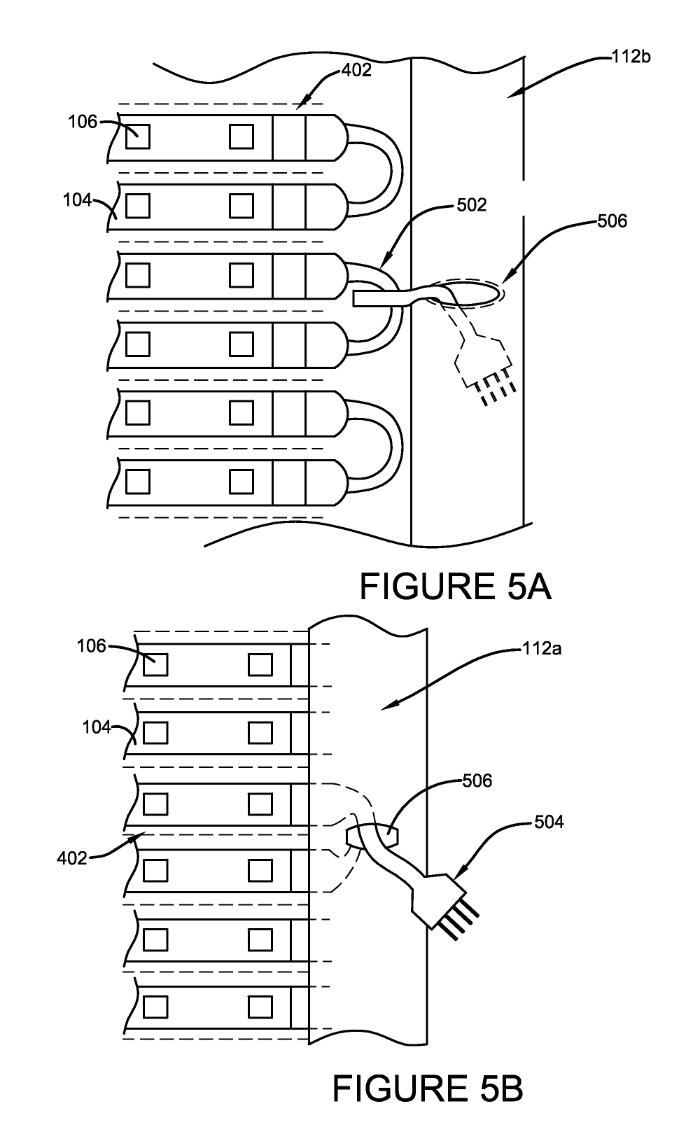

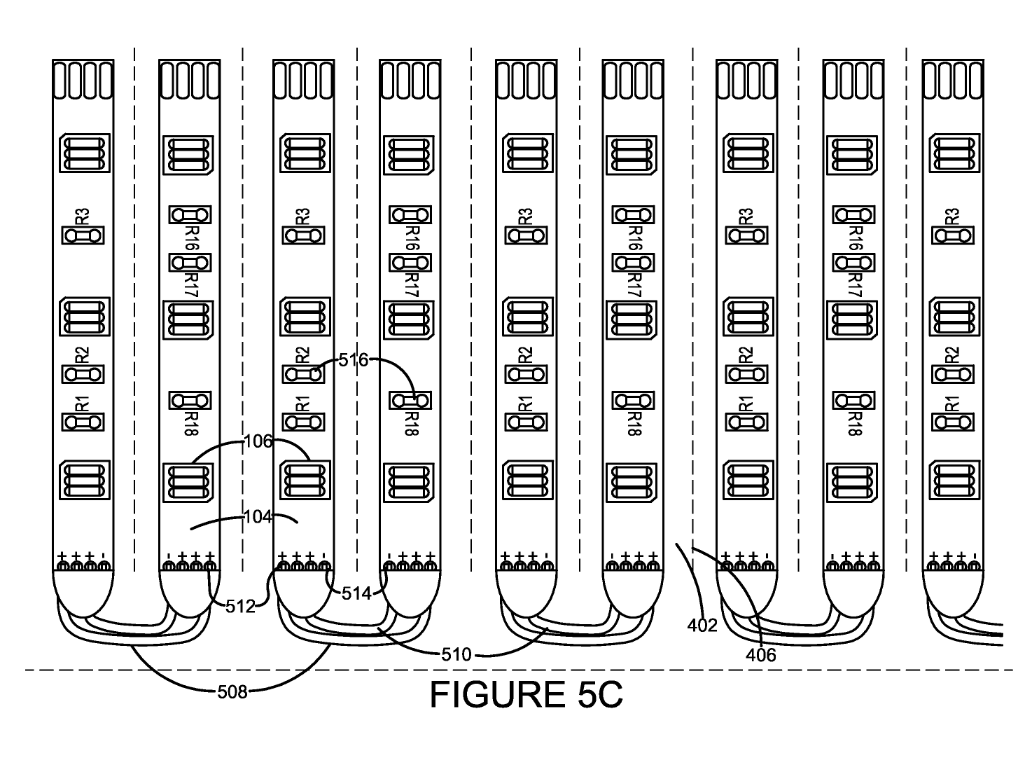

In one implementation, as illustrated in FIGS. 1-6, respective lighting elements may comprise a plurality of light emitting semiconductors 106. As one example, in FIG. 5C, an example lighting element 104 may comprise a strip arrangement, comprising a plurality of light emitting semiconductors 106 (e.g., LEDs), appropriate circuitry 516 configured to facilitate operation of the lighting element 104, and corresponding electrical connection 512, 514 for providing electrical connection to respective lighting elements 104.

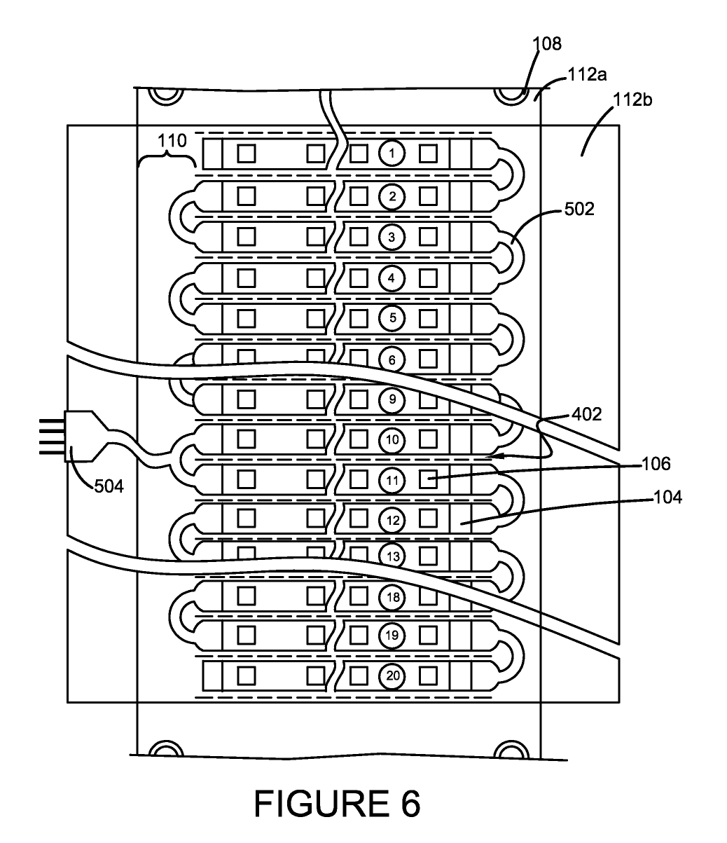

In one implementation, the plurality of lighting elements can be electrically coupled together in a serial configuration, as illustrated in FIGS. 5A, 5C, and 6. As an example, in FIG. 5C, respective lighting elements 104 can comprise one or more positive connection terminals 512 and one or more negative connection terminals 514. In this example, when two or more lighting elements are electrically coupled in series, adjacent positive connection terminals 512 may be coupled by a positive coupling wire 508, and adjacent negative connection terminals 514 may be coupled by a negative coupling wire 510.

Further, as illustrated in FIGS. 5A and 6, adjacent lighting elements 104 may be electrically coupled by an element coupler 502, for example, which may comprise one or more positive coupling wires 508 and one or more negative coupling wires 510. In this example, a first element coupler 502 can couple a first lighting element and a second lighting element at a first end; and a second element coupler 502 can couple the second lighting element and a third lighting element at a second end, and so-on.

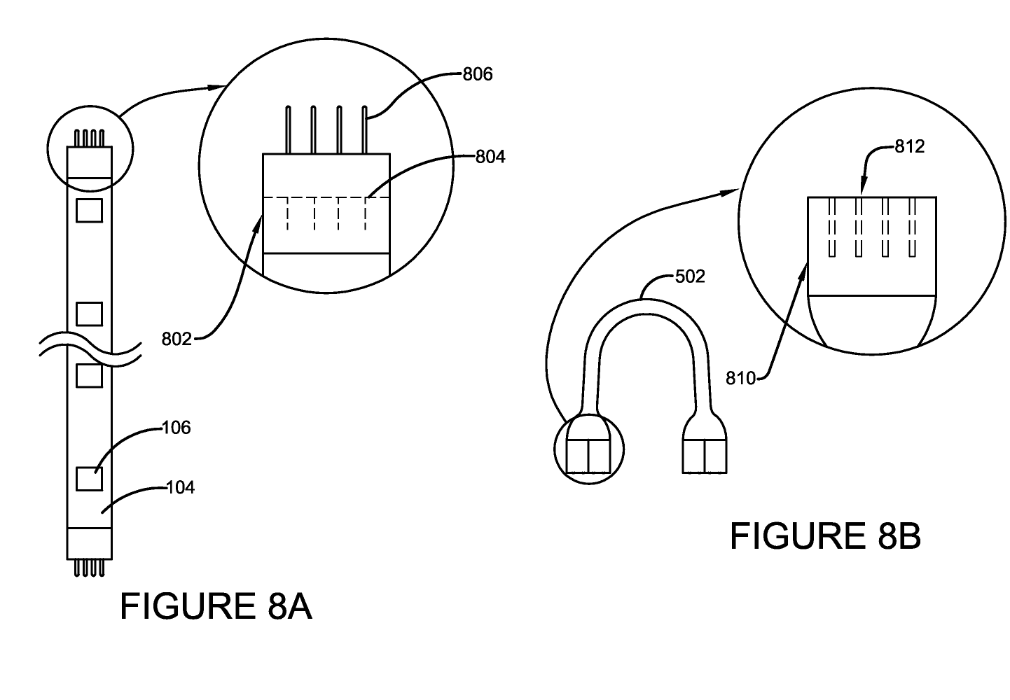

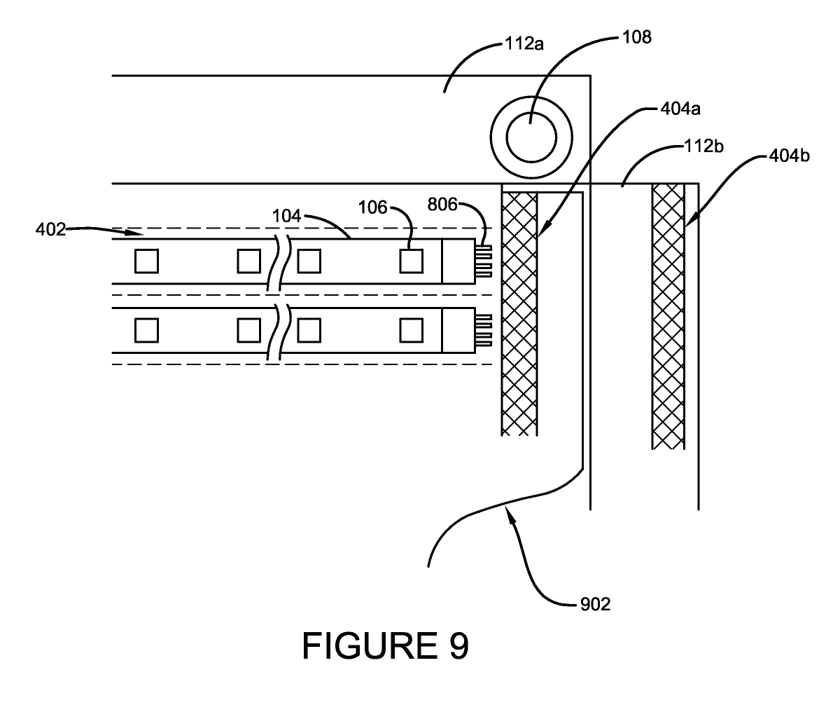

As an illustrative example, in FIGS. 8A, 8B, and 9 the element coupler 502 may comprise an element connector 810. In one implementation, the element connector 810 may be configured to selectively connect to a corresponding connection end 804 of a lighting element 104. For example, the element connector 810 may comprise female-type connection receptacles 812 that are configured to receive male-type connector pins 806 disposed on the connection end 804 of a lighting element 104. In this way, for example, the element coupler 502 may be used to connect respective lighting elements 104, such as in series. Further, as illustrated in FIGS. 5B, 6, and 11, the series of electrical connections may be electrically couples with an electrical supply connector 504, for example, configured to be connected to an electrical supply (e.g., a battery, electrical receptacle, etc.), such as through an electrical power supply line.

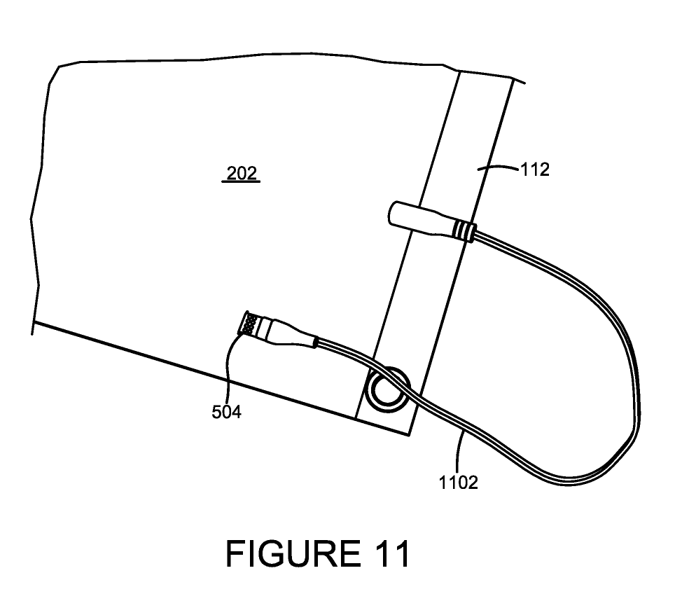

In one implementation, as illustrated in FIG. 11, the electrical supply connector 504 may be selectively coupled to an electrical power supply line extension 1102, which can be configured to selectively connect to an electrical supply line. For example, the supply connector 504 may be disposed adjacent to the exemplary panel, and comprise a male or female connector that is configured to selectively engage with a corresponding male or female connector of the electrical power supply line extension 1102. In this way, for example, the exemplary lighting panel 100 may be more easily arranged into the compact arrangement (e.g., as in FIG. 12B). In one implementation, as illustrated in FIG. 13B, the first lighting device 100a may comprise a first electrical power supply line extension 1102a, and the second lighting device 100a may comprise a first electrical power supply line extension (not shown), where the respective electrical power supply line extensions can be configured to be selectively coupled with an electrical power supply (e.g., combined or singly).

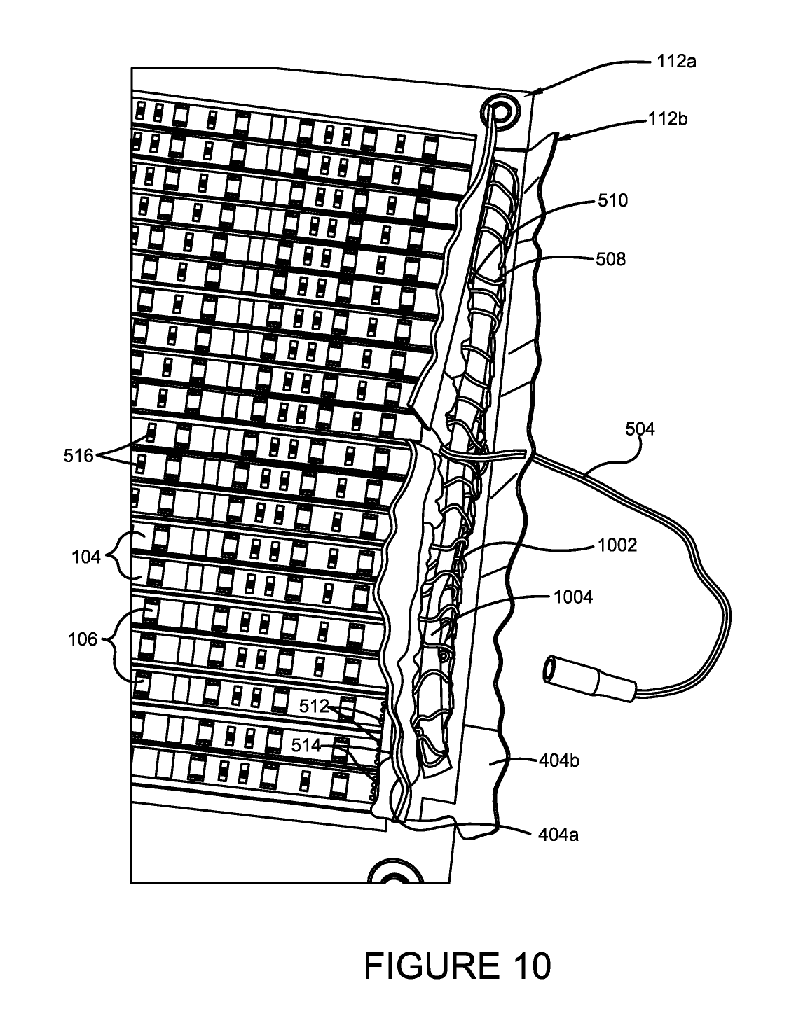

In another implementation, the respective lighting elements 104 may be electrically coupled in parallel. As an illustrative example, in FIG. 10, respective positive coupling wires 508 may be coupled with a common positive wire 1002; and respective negative coupling wires 510 may be coupled with a common negative wire 1004. Further, in this example, the common positive wire 1002 and common negative wire 1004 may be coupled with an electrical supply connector 504. In one implementation, the respective positive coupling wires 508 may be configured to be selectively coupled and/or uncoupled with the common positive wire 1002; and the respective negative coupling wires 510 may be configured to be selectively coupled and/or uncoupled with the common negative wire 1004, such as by using an electrical connector and receptacle (e.g., such as 804 and 810 of FIGS. 8A and 8B).

In one implementation, a lighting element 104 may be selectively removable from, and/or replaceable in, a pocket 402; and/or the wiring that electrically couples the respective lighting elements 104 may be selectively accessed for service. For example, as illustrated in FIGS. 1A, 1B, 3, 4, 5A and 5B, the exemplary lighting device 100 may comprise an enclosing edge 112 that may be configured to enclose the edge of the combined element holding panel 102 and base panel 202. For example, as illustrated in FIG. 1B, 4, 5A, 5B, and 9, the enclosing edge 112 may comprise a top side 112a and a bottom side 112b. In one implementation, the bottom side 112b may comprise a first part 404b of a fastener (e.g., a hook and loop fastener), that is configured to selectively engage a second part 404a of the fastener engaged with the base panel 202.

In this way, for example, the enclosing edge 112 may be selectively opened and/or closed to access or enclose the underlying electrical connections, and/or openings to the respective pocket 402. As an example, if a lighting element 104 becomes disabled, the enclosing edge 112 may be opened, an electrical coupler 502 can be uncoupled from the disabled lighting element 104, and the lighting element 104 may be removed from the corresponding pocket 402. Further, in this example, a functional lighting element 104 may be inserted into the empty pocket 402, and recoupled to the electrical coupler 502. The enclosing edge 112 may be subsequently closed, for example, to mitigate exposure of the electrical connections to potential damage.

In one implementation, as illustrated in FIGS. 13A and 13B, the base panel 202 can comprise one or more mounting means 108 that are configured to selectively engage with a lighting apparatus holding device 1302. For example, the lighting apparatus holding device 1302 may comprise rods (e.g., flexible rods), comprising an engagement end that can selectively engage with the mounting means 108, such as by inserting the engagement end into a through hole disposed in the base panel 202. Further, as an example, the flexible rods may be mounted to a stand 1304 that allows the exemplary lighting device 100 to be elevated or disposed in a desired location. For example, the lighting apparatus holding device 1302 can effectively spread the exemplary panel out into a desired use configuration, such that the respective lighting elements 104 are directed toward a desired subject (e.g., for image capture).

In one implementation, the mounting means 108 may be configured to couple a first lighting apparatus 100a to a second lighting apparatus 100b, as illustrated in FIG. 13B. In this example, fastening means 1306 (e.g., hook, loop, ring, carabiner, tie, etc.) may be selectively engaged with the mounting means 108 of the first lighting apparatus 100a, and mounting means 108 of the second lighting apparatus 100b to couple them together. In this way, for example, the combined lighting apparatuses 100a, 100b may provide increased lighting, and/or a desired arrangement of lighting, for a desired imaging subject.

The word “exemplary” is used herein to mean serving as an example, instance or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Further, at least one of A and B and/or the like generally means A or B or both A and B. In addition, the articles “a” and “an” as used in this application and the appended claims may generally be construed to mean “one or more” unless specified otherwise or clear from context to be directed to a singular form.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Of course, those skilled in the art will recognize many modifications may be made to this configuration without departing from the scope or spirit of the claimed subject matter.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

In addition, while a particular feature of the disclosure may have been disclosed with respect to only one of several implementations, such feature may be combined with one or more other features of the other implementations as may be desired and advantageous for any given or particular application. Furthermore, to the extent that the terms “includes,” “having,” “has,” “with,” or variants thereof are used in either the detailed description or the claims, such terms are intended to be inclusive in a manner similar to the term “comprising.”

The implementations have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

What is claimed is:

1. A lighting apparatus, comprising:
a base panel comprising a flexible material configured to be manipulated into:
a first configuration comprising a compact arrangement; and
a second configuration comprising a use arrangement;
a lighting element holding panel, operably engaged with said base panel, and comprising a plurality of pockets respectively configured to receive at least one lighting element, wherein said lighting element holding panel is comprised one or more of:
a flexible transparent material; and
a flexible translucent material; and
a plurality of lighting elements, respectively disposed in a pocket of said lighting element holding panel, respective lighting elements comprising one or more light emitting semiconductors configured to produce light.

2. The apparatus of claim 1, wherein said plurality of pockets are respectively disposed in a same orientation and are respectively configured to hold a lighting element in a same orientation.

3. The apparatus of claim 1, wherein said base panel comprises one or more mounting means configured to selectively engage with a lighting apparatus holding device.

4. The apparatus of claim 3, wherein said mounting means is further configured to couple a first lighting apparatus to a second lighting apparatus.

5. The apparatus of claim 1, wherein said plurality of lighting elements are electrically coupled together in one of:
a parallel configuration; and
a serial configuration.

6. The apparatus of claim 5, wherein said plurality of lighting elements are electrically coupled to an electrical power supply line.

7. The apparatus of claim 5, wherein said plurality of lighting elements are respectively configured to be selectively uncoupled from said electrical coupling.

8. The apparatus of claim 1, wherein respective pockets are configured to receive merely one lighting element, and wherein respective lighting elements comprise a plurality of said light emitting semiconductors.

9. The apparatus of claim 1, wherein said plurality of lighting elements are respectively selectively removable from said pocket.

10. The apparatus of claim 1, wherein:
said first configuration comprises a rolled-up panel configuration or a folded panel configuration; and
said second configuration comprises an unrolled or unfolded panel configuration.
